(19) United States
(12) Patent Application Publication
(10) Pub. No.: US 2016/0203804 A1
(43) Pub. Date: Jul. 14, 2016

(54) CYMBAL PROTECTION SYSTEM

(71) Applicant: Rodney Carpenter, SR., Winchester, IN (US)

(72) Inventor: Rodney Carpenter, SR., Winchester, IN (US)

(21) Appl. No.: 14/592,892

(22) Filed: Jan. 8, 2015

(51) Int. Cl. G10D 13/06

(52) U.S. Cl. CPC G10D 13/065

(57) ABSTRACT

A cymbal protection system includes a cymbal that has a top surface, a bottom surface and a peripheral edge extending therebetween. The cymbal has a bell and a bow and the cymbal has a disk shape. A cover is removably positioned on the cymbal to protect the cymbal. The cover is comprised of a resiliently compressible material such that the cover protects the cymbal from impact damage. An elastic band is coupled to the outer edge. The elastic band retains the cover on the cymbal.

### BACKGROUND OF THE DISCLOSURE

1. Field of the Disclosure

The disclosure relates to protection devices and more particularly pertains to a new protection device for protecting a cymbal from impact damage.

2. Summary of the Disclosure

An embodiment of the disclosure meets the needs presented above by generally comprising a cymbal that has a top surface, a bottom surface and a peripheral edge extending therebetween. The cymbal has a bell and a bow and the cymbal has a disk shape. A cover is removably positioned on the cymbal to protect the cymbal. The cover is comprised of a resiliently compressible material such that the cover protects the cymbal from impact damage. An elastic band is coupled to the outer edge. The elastic band retains the cover on the cymbal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a cymbal protection system according to an embodiment of the disclosure.

FIG. 2 is an edge view of an embodiment of the disclosure.

FIG. 3 is a top view of an embodiment of the disclosure.

FIG. 4 is a bottom view of an embodiment of the disclosure.

FIG. 5 is a perspective in-use view of an embodiment of the disclosure.

### DESCRIPTION OF THE PREFERRED EMBODIMENT

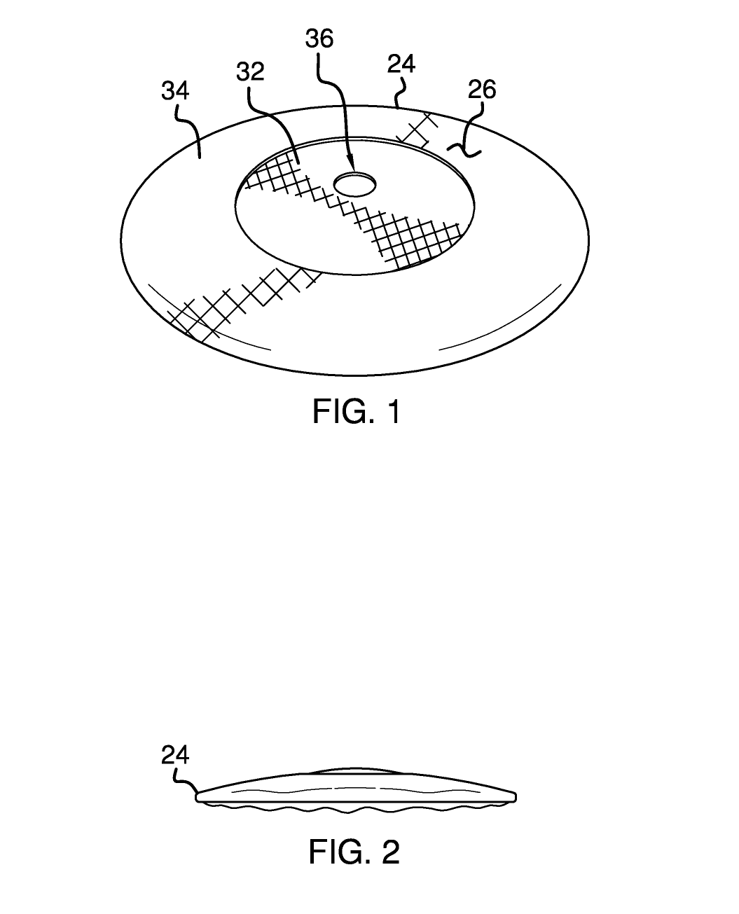

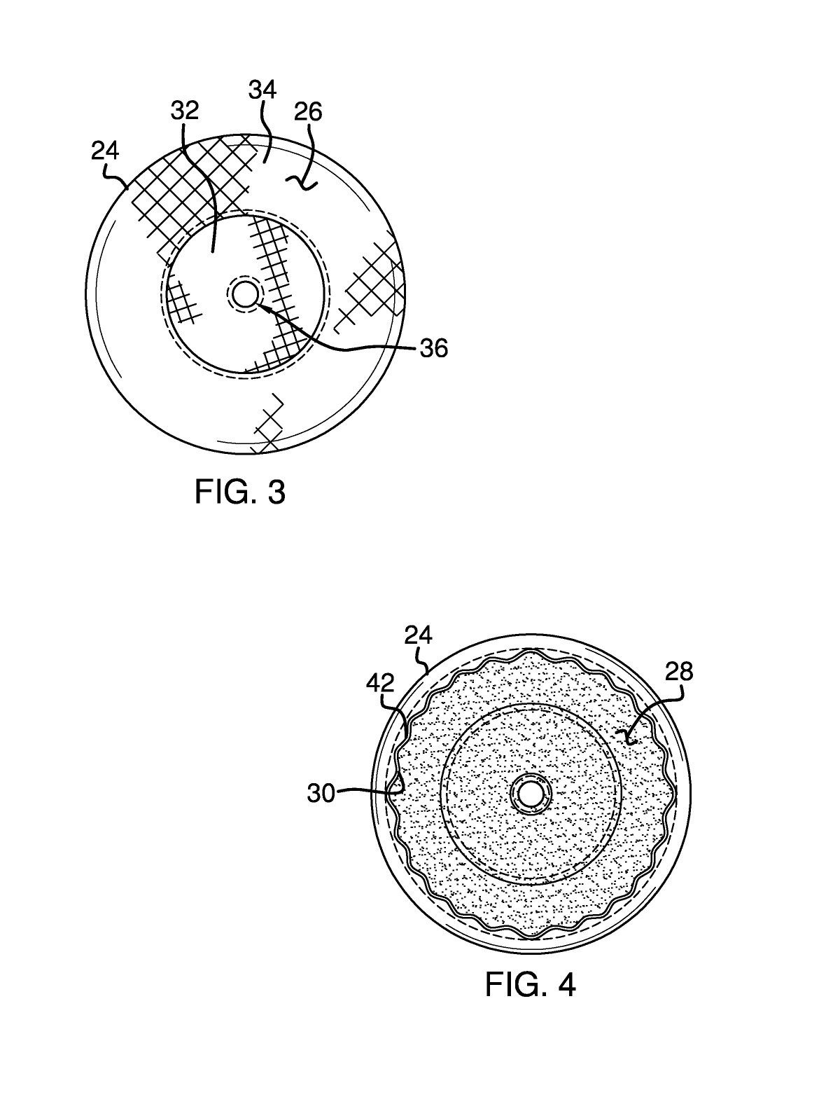

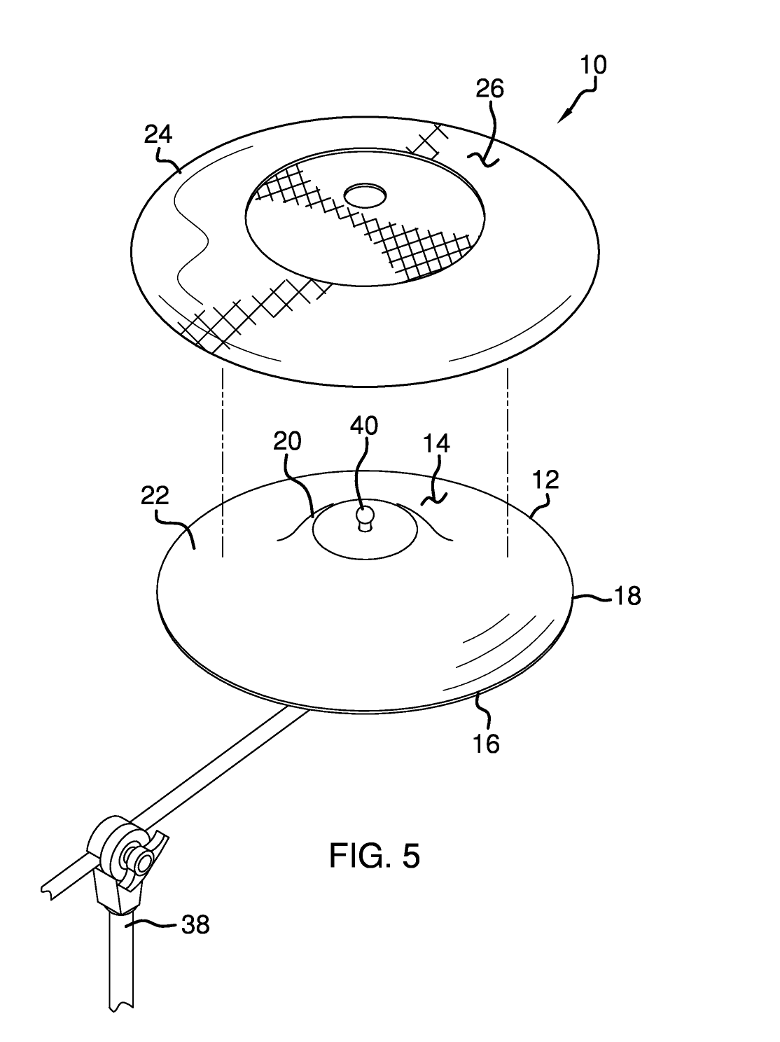

With reference now to the drawings, and in particular to FIGS. 1 through 5 thereof, a new protection device embodying the principles and concepts of an embodiment of the disclosure and generally designated by the reference numeral 10 will be described.

As best illustrated in FIGS. 1 through 5, the cymbal protection system 10 generally comprises a cymbal 12 that has a top surface 14, a bottom surface 16 and a peripheral edge 18 extending therebetween. The cymbal 12 has a bell 20 and a bow 22 and the cymbal 12 has a disk shape. The cymbal 12 may be a percussive cymbal of any conventional design.

A cover 24 is removably positionable on the cymbal 12 to protect the cymbal 12. The cover 24 has an upper surface 26, a lower surface 28 and an outer edge 30 extending therebetween. The lower surface 28 abuts the top surface 14 when the cover 24 is positioned on the cymbal 12. The cover 24 has a central section 32 and an outer section 34. The central section 32 is convexly arcuate with respect to the outer section 34.

The central section 32 covers the bell 20 and the outer section 34 covers the bow 22. The central section 32 has an opening 36 extending through the upper surface 26 and the lower surface 28. The cymbal 12 may be mounted on a stand 38 and a fastener 40 retains the cymbal 12 on the stand 38. The fastener 40 extends through the opening 36 when the cover 24 is positioned on the cymbal 12. The cover 24 has a disk shape and the cover 24 is comprised of a resiliently compressible material to protect the cymbal 12 from impact damage. The resiliently compressible material may comprise neoprene or the like.

An elastic band 42 is coupled to the outer edge 30. The elastic band 42 is coextensive with the outer edge 30 and the elastic band 42 urges the outer edge 30 inwardly toward the opening 36. The elastic band 42 urges the outer edge 30 around the peripheral edge 18 and onto the bottom surface 16 when the cover 24 is positioned on the cymbal 12. The elastic band 42 retains the cover 24 on the cymbal 12.

In use, the cover 24 is placed on the cymbal 12 while the cymbal 12 is on the stand 38 or after the cymbal 12 has been removed from the stand 38. The cover 24 is left on the cymbal 12 until the cymbal 12 is to be utilized.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cymbal protection system configured to protect a cymbal when the cymbal is not in use, said assembly comprising:
a cymbal having a top surface, a bottom surface and a peripheral edge extending therebetween, said cymbal having a bell and a bow, said cymbal having a disk shape;
a cover being removably positioned on said cymbal to protect said cymbal, said cover being comprised of a resiliently compressible material such that said cover protects said cymbal from impact damage, said cover having an upper surface and a lower surface, said lower surface abutting said top surface when said cover is positioned on said cymbal, said cover having a central section and an outer section, said central section being convexly arcuate with respect to said outer section wherein said central section fully contacts, covers and conforms to said bell, said outer section covering said bow, said central section having an opening extending through said upper surface and said lower surface, said cover having a disk shape; and
an elastic band coupled to an outer edge of said cover, said elastic band retaining said cover on said cymbal.

2. (canceled)

3. (canceled)

4. The assembly according to claim 1, wherein said elastic band is coextensive with said outer edge, said elastic band urging said outer edge inwardly toward said opening, said elastic band urging said outer edge around said peripheral edge and onto said bottom surface when said cover is positioned on said cymbal.

5. A cymbal protection system configured to protect a cymbal when the cymbal is not in use, said assembly comprising:
a cymbal having a top surface, a bottom surface and a peripheral edge extending therebetween, said cymbal having a bell and a bow, said cymbal having a disk shape;
a cover being removably positioned on said cymbal to protect said cymbal, said cover having an upper surface, a lower surface and an outer edge extending therebetween, said lower surface abutting said top surface when said cover is positioned on said cymbal, said cover having a central section and an outer section, said central section being convexly arcuate with respect to said outer section wherein said central section fully contacts, covers and conforms to said bell, said outer section covering said bow, said central section having an opening extending through said upper surface and said lower surface, said cover having a disk shape, said cover being comprised of a resiliently compressible material such that said cover protects said cymbal from impact damage; and
an elastic band coupled to said outer edge, said elastic band being coextensive with said outer edge, said elastic band urging said outer edge inwardly toward said opening, said elastic band urging said outer edge around said peripheral edge and onto said bottom surface when said cover is positioned on said cymbal, said elastic band retaining said cover on said cymbal.
